(19) United States
(12) Patent Application Publication
(10) Pub. No.: US 2007/0032273 A1
(43) Pub. Date: Feb. 8, 2007

(54) ACCESSORY OF A PORTABLE ELECTRONIC DEVICE

(76) Inventors: Fu-Yuan Hsiao, Tai-Chung City (TW); Chun-Yin Hua, Kao-Hsiung City (TW); Chien-Feng Chan, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,819

(22) Filed: Jan. 12, 2006

(30) Foreign Application Priority Data
Aug. 4, 2005 (TW) 094126562

(51) Int. Cl. H04M 1/00

(52) U.S. Cl. 455/575.1

(57) ABSTRACT

An accessory utilized in a portable electronic device includes: a housing; a connecting port placed on the housing, for electrically connecting an output port of the portable electronic device in order to receive an audio signal output by the portable electronic device; an audio signal outputting module placed inside the housing and electrically connected to the connecting port, for processing and outputting the audio signal; and a fixing module, placed on the housing, for locking the portable electronic device and the accessory such that the accessory can move with the portable electronic device.

### BACKGROUND OF THE INVENTION

1. Field of the Invention

The invention relates to an accessory of a portable electronic device, and more particularly, to an accessory having an audio signal outputting module and a fixing module.

2. Description of the Prior Art

Portable electronic devices, for example, cell phones, personal digital assistants (PDA), USB flash memories etc. play a significant role in modern life, having characteristics of both low weight and small volume. The most essential and widely utilized portable electronic device from this group is undoubtedly the cell phone. Today's cell phones can provide not only a conventional telecom function but also provide users with better service quality by combining internet technology with mobile communication technology. In many modern societies and cities, cell phones are prevalent, with many people even owning more than one. Therefore, cell phone manufacturers and service providers are now paying increasing attention to the cell phone market.

The increase in popularity of cell phones has resulted in many accessories for cell phones being provided. In the consumer market there is a huge variety of accessories to compliment the wide variety of cell phones already available. As well as increasing the value of the cell phone, these accessories are also used as fashion statements or status symbols.

A recent development in the market is that many cell phones now support MP3 encoding/decoding formats and polyphonic ring tones. The embedded amplifier in a conventional cell phone cannot amplify low-frequency audio signals well, however. In other words, conventional cell phone amplifiers cannot completely achieve the full effect of the polyphonic ring tones. To solve this problem, many cell phones have been equipped with corresponding external woofers as accessories. A further problem arises from this, however. The external woofers may be too large and heavy for users to carry, and must therefore be fixed on a flat surface in order to play music. Obviously, the above-mentioned solution is inadequate.

### SUMMARY OF THE INVENTION

It is therefore one of the primary objectives of the claimed invention to provide a portable accessory having an audio signal outputting module and a fixing module, to solve the above-mentioned problem.

According to an exemplary embodiment of the claimed invention, an accessory to be utilized with a portable electronic device is disclosed. The accessory comprises: a housing; a connecting port placed on the housing, for electrically connecting one output port of the portable electronic device to receive an audio signal outputted by the portable electronic device; an audio signal output module, placed inside the housing and electrically connected to the connecting port, for processing and outputting the audio signal; and a fixing module, placed on the housing, for locking the portable electronic device and the accessory such that the accessory can move with the portable electronic device.

The present invention accessory of the portable electronic device comprises an audio signal outputting module and a fixing module, where the audio signal outputting module can be utilized to amplify audio signals generated by the portable electronic device (for example, the audio signal outputting module can amplify low-frequency audio signals), and the fixing module can lock the accessory to the portable electronic device thereby allowing the present invention accessory to move with the portable electronic device. The prior art disadvantage, i.e. the external woofer being difficult to carry, can therefore be solved. In addition, the present invention accessory can support the portable electronic device such that the portable electronic device can be erected on a flat surface. To sum up, the present invention accessory provides a novel solution for users to enjoy better quality audio signals in a fully portable device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a three-dimensional view of a portable accessory of a first embodiment according to the present invention.

FIG. 2 is a diagram illustrating the combination of the accessory and the portable electronic device shown in FIG. 1.

FIG. 3 is a three-dimensional view of a portable accessory of a second embodiment according to the present invention.

FIG. 4 is a diagram illustrating the combination of the accessory and the portable electronic device shown in FIG. 3.

FIG. 5 is a diagram illustrating when the accessory is utilized as a support of the portable electronic device.

### DETAILED DESCRIPTION

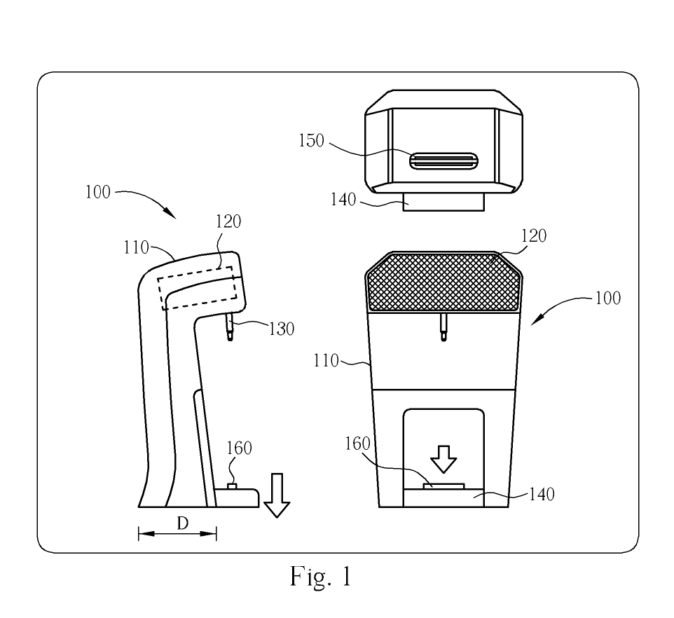

Please refer to FIG. 1, which is a three-dimensional view of a portable accessory 100 of a first embodiment according to the present invention. As shown in the side-view of the accessory 100 in FIG. 1, the accessory 100 comprises a housing 110, an audio signal outputting module 120 placed inside the housing 110, a connecting port 130 placed on the housing 110, and a fixing module 140 placed on the housing 110. The fixing module 140 is utilized to fix the accessory 100 to the portable electronic device. In addition, as shown in the top view of the accessory 100, the portable accessory 100 further comprises a suspending ring 150 placed on the housing 110. Please note that in this embodiment the audio signal outputting module 120 can be an amplifier or a woofer, electrically connected to the connecting port 130, for receiving audio signals generated by the portable electronic device, amplifying the audio signals, and outputting amplified audio signals. The fixing module 140 can be moved in the direction of the arrow shown in FIG. 1 such that the portable electronic device can be placed inside the U-shaped space of the accessory 100. Moreover, the portable electronic device is fixed by the accessory 100 through the connecting port 130 and the locking device 160 of the fixing module 140.

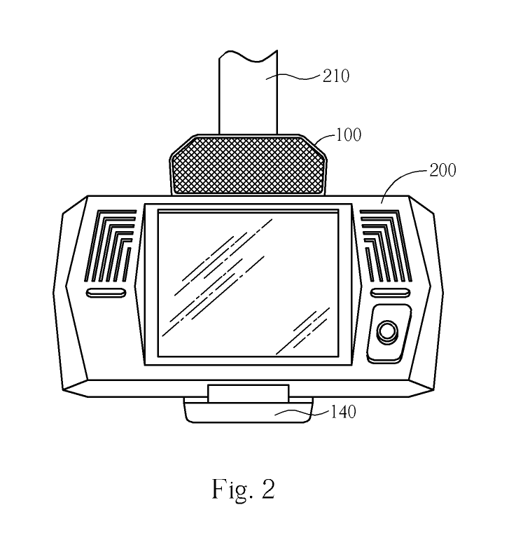

Please refer to FIG. 2, which is a diagram illustrating the combination of the accessory 100 and the portable electronic device 200. As shown in FIG. 2, in this embodiment, the portable electronic device 200 is a cell phone. However, the present invention accessory 100 is not limited to be utilized in cell phones; for example, the accessory 100 can be utilized in a portable electronic device that generates audio signals, such as a personal digital assistant (PDA) or an MP3 walkman.

In this embodiment, one side of the cell phone 200 has a connecting port (not shown) for connecting to the connecting port 130 of the accessory 100. In addition, the other side of the cell phone 200 has a fillister (not shown) for placing the locking device 160. Therefore, as shown in FIG. 2, the accessory 100 and the cell phone 200 can be connected to each other through the connecting port 130 and the locking device 160. Furthermore, for ease of portability, the accessory 100 comprises the aforementioned suspending ring 150. The suspending ring 150 can be utilized to connect to a belt 210 such that users can utilize the belt 210 to carry the cell phone 200.

In addition, please refer to FIG. 2 in conjunction with FIG. 1. Because of the housing 110 of the accessory 100, after the accessory 100 is combined with the cell phone 200, the accessory 100 can be a base of the cell phone 200. Therefore, the cell phone 200 can be erected on a flat surface as shown in FIG. 2 and operated as a standing-type amplifier. The present invention accessory 100 can be utilized as not only a woofer (amplifier) of the cell phone 200, but also as a base of the cell phone 200. Furthermore, the accessory 100 allows users to carry the cell phone 200 through the attachment of the belt 210 and the suspending ring 150. In other words, the accessory 100 improves the quality of the original function (audio signal outputting) increases the ease of portability of the cell phone 200, and has multiple functions when the cell phone 200 is placed on a surface. Moreover, the housing 110, the belt 210, or the overall shape of the accessory 100 can be designed to be fashionable and thereby raise users' desire to buy them.

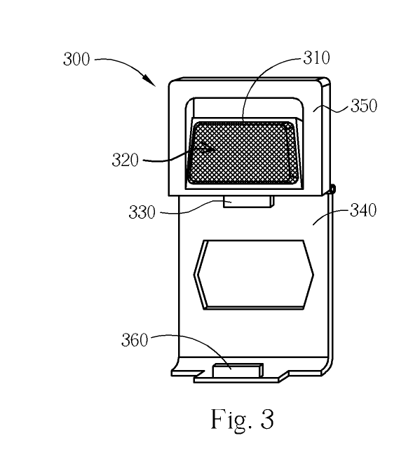

Please refer to FIG. 3, which is a portable accessory 300 of a second embodiment according to the present invention. As shown in FIG. 3, the portable accessory 300 also comprises a housing 310, an audio signal outputting module 320 placed inside the housing 310, a connecting port 330 placed on the housing 310, a fixing module 340, and a suspending ring 350 placed on the housing 310. Similar to the first embodiment, the audio signal outputting module 320 can be a woofer utilized for receiving audio signals (generated by the portable electronic device) from the connecting port 330, amplifying the audio signals, and outputting the amplified audio signals. The fixing module 340 also comprises a locking device 360. Furthermore, as shown in FIG. 3, the fixing module 340 is connecting to the housing 310 through a hinge. Therefore, the fixing module 340 can rotate through the hinge to place the portable electronic device into the U-shaped space of the fixing module 340. The portable accessory 300 can lock itself to the portable electronic device through the connecting port 330 and the locking device 360 of the fixing module 340.

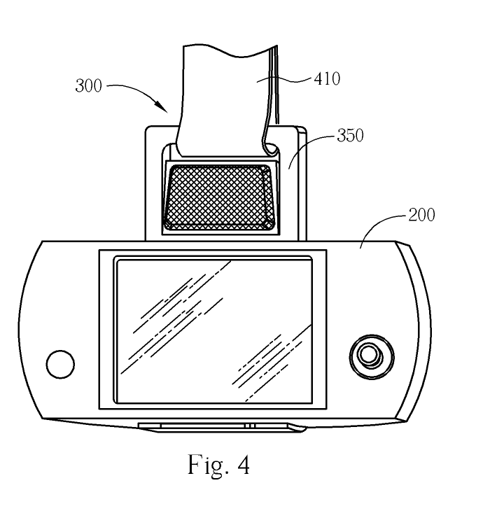

Please refer to FIG. 4, which is a diagram illustrating the combination of the accessory 300 and the portable electronic device 200 shown in FIG. 3. For clear illustration purposes, the cell phone 200 is utilized again as an application of the accessory 300. As aforementioned, the accessory 300 can be utilized in all kinds of portable electronic devices and the cell phone 200 is only utilized as a preferred embodiment, and not a limitation of the present invention.

As mentioned previously, the side of the cell phone 200 has a connecting port such that the connecting port 330 can be connected into the connecting port of the cell phone 200. Furthermore, the other side of the cell phone 200 has a fillister for placing the locking device 360. Therefore, as shown in FIG. 4, the accessory 300 and the cell phone 200 are combined through the connecting port 330 and the locking device 360. In addition, for ease of carrying, the portable accessory 300 comprises the above-mentioned suspending ring 350. As before, the suspending ring 350 can be utilized for connecting to a belt 410. The users can utilize the belt 410 to wear the cell phone 200 in order to carry the cell phone 200 and the accessory 300.

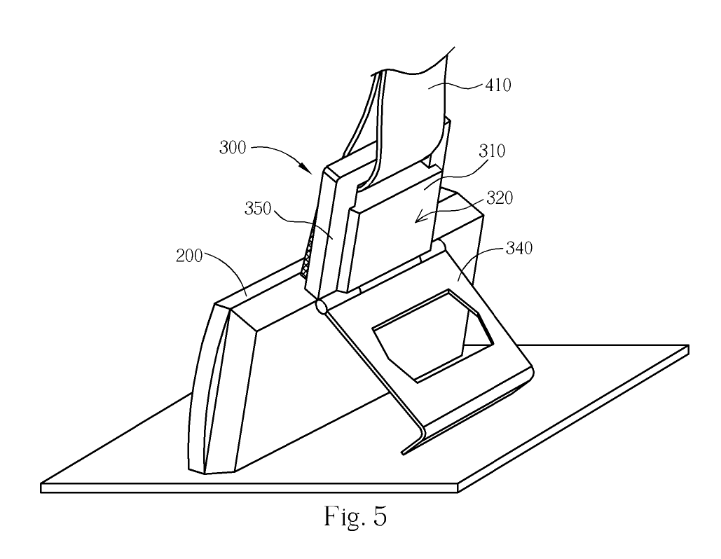

Please refer to FIG. 5, which is a diagram illustrating when the accessory 300 is utilized as a supporter of the portable electronic device 200. As shown in FIG. 5, because the fixing module 340 can rotate due to the hinge, the fixing module 340 can rotate by a predetermined angle to be the supporter of the cell phone 200. This allows the cell phone 200 to be erected on a flat surface. In other words, the cell phone 200 is utilized as a standing-type amplifier by this arrangement. Similar to the accessory 100, the accessory 300 raises the quality of the original function (audio signal outputting) and the portability of the cell phone 200, and has multiple functions when the cell phone 200 is placed on a flat surface. The accessory 300 can be further combined with a well-designed belt 410 and cell phone 200 to make the accessory 300 and the cell phone 200 fashionable items.

Please note that the types of suspending ring and belt utilized in the present invention are not limited. For example, the suspending ring can be a hole on the accessory 300, so the belt only has to go through the hole to achieve the purpose of suspending the cell phone.

In contrast to the prior art, the present invention accessory of the portable electronic device comprises an audio signal outputting module and a fixing module, where the audio signal outputting module can be utilized to amplify audio signals generated by the portable electronic device (for example, the audio signal outputting module can amplify low-frequency audio signals), and the fixing module can lock the accessory to the portable electronic device. Therefore, the present invention accessory can move with the portable electronic device. The prior art disadvantage, i.e. the external woofer is not easily portable, can be solved. In addition, the present invention accessory can support the portable electronic device such that the portable electronic device can be erected on a flat surface. To sum up, the present invention accessory provides a novel solution for users to enjoy a better quality of audio signals in a fully portable device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An accessory utilized in a portable electronic device, the accessory comprising:
a housing;
a connecting port, placed on the housing, for electrically connecting one output port of the portable electronic device to receive an audio signal outputted by the portable electronic device;
an audio signal output module, placed inside the housing and electrically connected to the connecting port, for processing and outputting the audio signal; and
a fixing module, placed on the housing, for locking the portable electronic device and the accessory such that the accessory can move with the portable electronic device.

2. The accessory of claim 1 further comprising:
a suspending ring, placed on the housing; and
a belt, connected to the suspending ring.

3. The accessory of claim 1, wherein one end of the housing is a plane, and the accessory is capable of being utilized as a base of the portable electronic device in order to erect the portable electronic device on a contacting plane.

4. The accessory of claim 1, wherein the fixing module is placed on the housing in a rotational way, so if the fixing module is rotated at a first position, the fixing module locks the accessory to the electronic device, and if the fixing module is rotated at a second position, the fixing module is capable of being a supporter to support the portable electronic device such that the portable electronic device is erected on a contacting plane.

5. The accessory of claim 1, wherein the audio signal output module is a woofer.

6. The accessory of claim 1, wherein the audio signal output module is an amplifier.

7. The accessory of claim 1, wherein the portable electronic device is a cell phone.
